(19) United States
(12) Patent Application Publication
(10) Pub. No.: US 2009/0302244 A1
(43) Pub. Date: Dec. 10, 2009

(54) SQUEEZE VALVE

(76) Inventor: Matthias Wedel, Nurnberg (DE)

Correspondence Address: BRINKS HOFER GILSON & LIONE, P.O. BOX 10395, CHICAGO, IL, 60610, US

(21) Appl. No.: 12/473,962

(22) Filed: May 28, 2009

(30) Foreign Application Priority Data
Jun. 5, 2008 (DE) 10 2008 026 851.8

(51) Int. Cl. F16K 7/07; F16K 7/04

(52) U.S. Cl. 251/5; 251/4

(57) ABSTRACT

A clamp valve is provided. A clamp valve or a squeeze valve may be straight-way valves, which include a tubular shut-off element, which is sometimes arranged in a tubular housing made of metal or plastic. The tubular shut-off element is either squeezed together mechanically or by an externally supplied foreign medium until the closed position is achieved. In one embodiment, a squeeze valve includes a first flexible tubular segment, the cross-section of which can be influenced by a first tube squeezing apparatus and a second flexible tubular segment, the cross-section of which can be changed by a second tube squeezing apparatus. The tube squeezing apparatuses may be controlled such that an opening process of the second tubular segment is executed at the same time as a closing process of the second tubular segment.

The present patent document claims the benefit of German Patent Application DE 10 2008 026 851.8 filed on Jun. 5, 2008, which is hereby incorporated by reference.

### BACKGROUND

The present embodiments relate to squeeze valves.

Squeeze valves are straight-way valves, which include a tubular shut-off element. The shut-off element is arranged in a tubular housing made of metal or plastic. The tubular shut-off element is either squeezed together mechanically or by an externally supplied foreign medium until the closed position is achieved. A squeeze valve may be referred to as a clamp valve.

Squeeze valves are primarily used as shut-off instruments for liquid media or solids. Different tubular sleeve designs render the squeeze valves suitable for controlling very different media. As a result, squeeze valves are used in various fields, for instance, in the food processing industry and the chemical industry as well as in medical engineering. During an infusion using a drip, the dosing of the drip speed is performed by a roller clamp that operates as a squeeze valve in conjunction with a flexible tube.

FIG. 1 shows a known mechanical squeeze valve 10. FIG. 1A indicates the completely opened state and FIG. 1B indicates the completely closed state. Squeeze valve 10 includes a flexible tube 11 between a punching tool 13 and a thrust bearing 12. Squeeze valve 10 is actuated by punching tool 13 being moved in the direction of the thrust bearing 12 (shown by arrow 16), with the tube 11 located therebetween being pressed together accordingly and the tube diameter which is effective in terms of transporting a medium 14 reducing. An arrow 15 in FIG. 1A shows the transport direction of the medium.

FIG. 2 shows a known squeeze valve 20 which is actuated by a foreign media. FIG. 2A indicates the completely opened state and FIG. 2B indicates the completely closed state. Squeeze valve 20 includes a flexible tube segment 21, which is surrounded by a pressure tank 22 which is filled with the foreign medium 23. Squeeze valve 20 is actuated by the pressure in the foreign medium 23 being increased (indicated by arrow 26), with the flexible tube part 12 inside the pressure tank 22 being pressed together accordingly and the tube diameter which is effective in terms of transporting a medium 23 reducing. An arrow 25 in FIG. 2A shows the transport direction of the medium.

A change in pressure or volume flow develops along the tube when closing the known squeeze valves 10, 20. The change in pressure or volume flow is indicated in FIG. 1B by arrows 17 and in FIG. 2B by arrows 27. The volume flow corresponds to the squeezed tube volume and spreads in both directions from the valve 10, 20 in the tube. The ratios when opening the valve 10, 20 are correspondingly inverse.

This behavior is problematic, particularly the flow occurring in the discharge line, when small quantities of the medium 14, 24 are to be dosed or refluxes have to be prevented. If two-component adhesives are to be mixed in a dosing chamber, for example, the reflux of the hardening agent into the line can block the line since already mixed adhesive reaches the line. In a medical application, the dosing of a medicine could change if the valve is closed or blood could enter the catheter when opening the valve, and could be changed there by contact with a concentrated medicine and result in complications in the case of a subsequent injection.

### SUMMARY AND DESCRIPTION

The present embodiments may obviate one or more of the problems or drawbacks inherent in the related art. For example, in one embodiment, a squeeze valve may prevent the volume flow in the tube at least in one direction.

In one embodiment, a squeeze valve may include a first flexible tubular segment and a second flexible tubular segment. The cross-section of the first flexible tubular segment can be influenced by a first tube squeezing apparatus. The cross-section of the second flexible tubular segment can be changed by a second tube squeezing apparatus. The tube squeezing apparatuses being controlled such that an opening process of the second tubular segment is executed at the same time as a closing process of the first tubular segment and vice versa.

The change in volume at the second tubular segment may correspond to at least approximately half of the change in volume at the first tubular segment.

The squeeze valve may include an equalization apparatus in the form of a second flexible tubular segment with a second tube squeezing apparatus. Accordingly, it is possible to avoid an outwardly effective change in volume on one side of the valve when opening and/or closing the valve, since the change in volume acting in the direction and caused by the first tube squeezing apparatus forming the valve in the narrower sense is compensated by a suitable countermovement of the compensating device.

A squeeze valve may include an equalization apparatus on both sides. It is thus irrelevant how the actuation of the valve is effected and how the coupling of the tube squeezing apparatuses takes place. Mechanical, hydraulic, or pneumatic actuations and the same couplings in any combination are conceivable.

### BRIEF DESCRIPTION OF THE DRAWINGS

FIG. 1 shows a known mechanical squeeze valve;

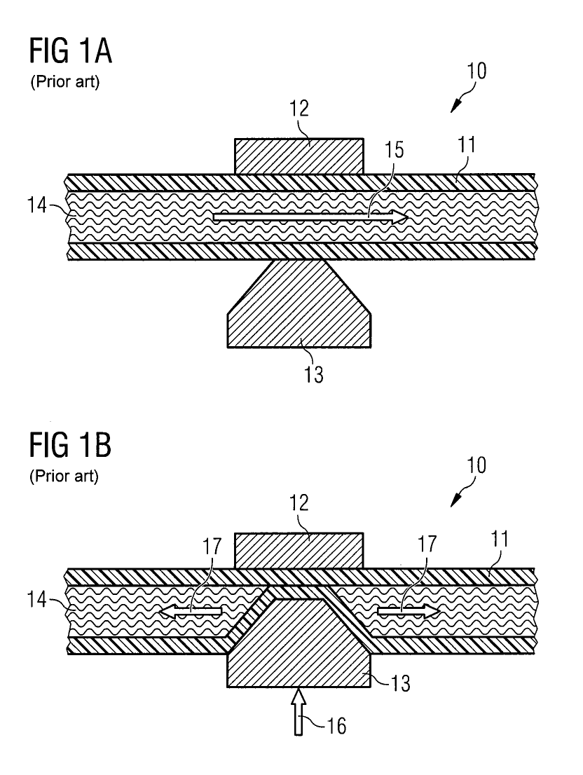

FIG. 2 shows another known squeeze valve;

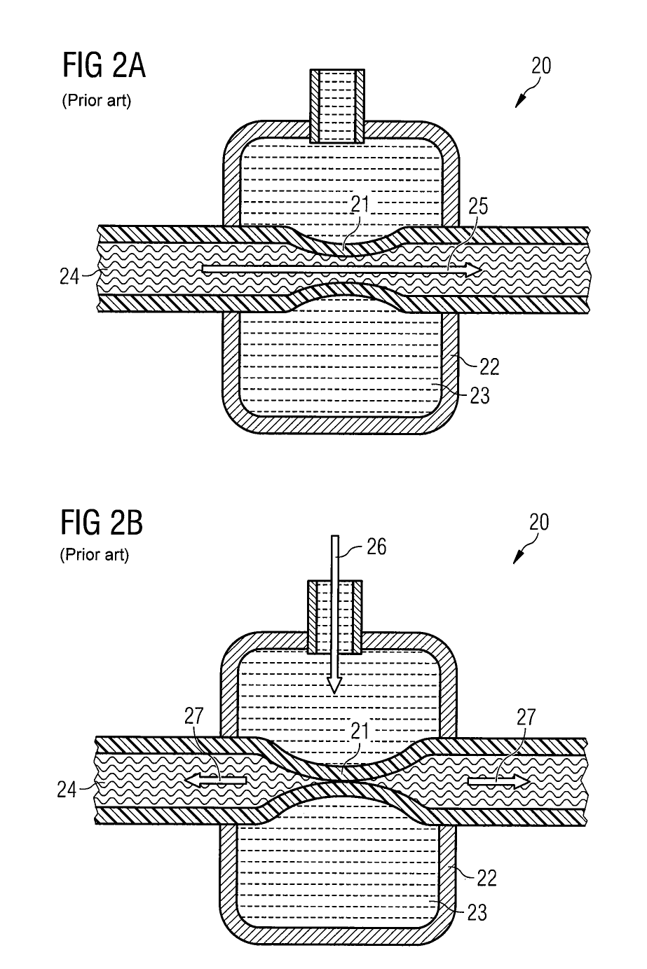

FIG. 3 shows a first exemplary embodiment of a squeeze valve with mechanical control of the tube squeezing apparatuses;

FIG. 4 shows a second exemplary embodiment of a squeeze valve with a mechanical control of the tube squeezing apparatuses; and

FIG. 5 shows a third exemplary embodiment of a squeeze valve with a hydraulic control of the tube squeezing apparatuses.

### DETAILED DESCRIPTION

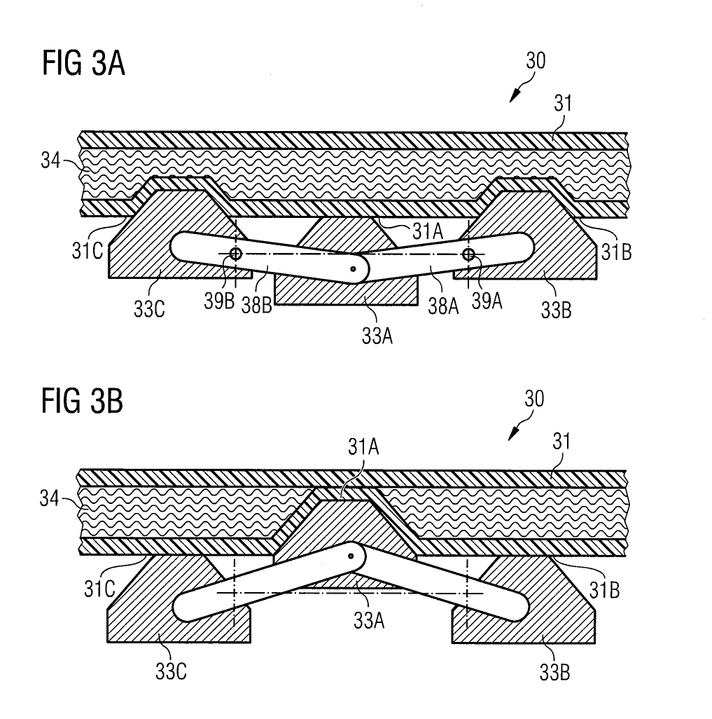

A first exemplary embodiment of a squeeze valve 30 is shown in FIG. 3. FIG. 3A indicates the completely opened state and FIG. 3B indicates the completely closed state. Squeeze valve 30 includes a tube 31 with three flexible tubular segments 31A, 31B and 31C and associated tube squeezing apparatuses 33A, 33B and 33C. Alternatively, the tubular part 31 may be equally as flexible, thereby simplifying the design.

Segment 31A is a tubular segment which is used for flow regulation. The tubular segments 31B and 31C are used to equalize the change in volume brought about by opening or closing segment 31A.

The primary punching tool 33A on segment 31A is coupled to two secondary punching tools 33B, 33C by two levers 38A, 38B, which are rotatably mounted in points 39A, 39B. In the opened valve state (FIG. 3A), the two secondary punching tools 33B, 33C compress the respective tubular segments 31B, 31C to such a degree that the volume of the medium 34 which is displaced thereby corresponds at least approximately to the half of the volume of the medium 24, which is displaced by the assigned tubular segment 31A in the case of a complete closure of the primary punching tool 33A (FIG. 3B).

The geometry and arrangement of the moveable parts, such as the punching tool 33A-C, lever 38A, B and the respective lever arms, may be selected such that the change in volume produced by the movement of the primary punching tool 33A in the squeezing area 31A is at least approximately twice as large as the change in volume in the squeezing areas 31B, C brought about by the opposite movement of the secondary punching tool 33B, C.

During operation of the valve 30, a change in volume may be brought about by the movement of the primary punching tool 33A to be compensated for on both sides by the movement of the secondary punching tool 33B, 33C. Pressure and/or volume outside the valve do not change as a result of actuating the primary punching tool 33A.

The squeeze valve 30 may include a one-sided equalization apparatus, for example, if only one side (inflow or outflow) of the valve is sensitive to change in volumes. The other equalization punching tool and the corresponding lever may be left out.

The coupling of the three punching tools 33A-C takes place mechanically in the exemplary embodiment in FIG. 3, but can however also take place hydraulically or electromechanically or by an electronic controller with corresponding electrically controlled punching tools 33A-C.

The quantity which has already flowed may not be changed by wear of the tube. This is important with medication dosing, for example. Medium (possibly contaminated) is not drawn back in and the flow direction remains constant. There are no overpressures in the inflow, so that dosing pumps used there are not influenced by repercussive pressures. The squeezing profile may be designed in an almost wear-free and flexible fashion. No particularly small squeezing cross-section needs to be provided in order to keep the change in volume small, since any size of change in volumes can in principle be compensated. The correspondingly lower mechanical loads allow (cheaper) tubular materials to be used.

A thrust bearing may be attached if opposite to the punching tool 33A-C. Instead of punching tools, pincer-like squeezing apparatuses can be used. The pincer-like squeezing apparatuses may constrict the tube on two sides. Surrounding squeezing apparatuses may be used. The surrounding squeezing apparatuses may be operated electromechanically and may surround and constrict the whole periphery of the tube.

The apparatus may be dimensioned such that a subpressure takes effect (contrary to the overpressure developing in the case of conventional squeeze valves) on the inflow and outflow (not shown) when the primary punching tool 33A is closed. Only the volume displaced by the secondary punching tool 33B, C in the opened valve state has to be greater than the half of the volume which can be displaced by the primary punching tool.

Other tube geometries may be equipped with squeeze valves, for example, different tubular diameters on the inflow and outflow. Accordingly, only the secondary punching tools may have to be suitably adjusted.

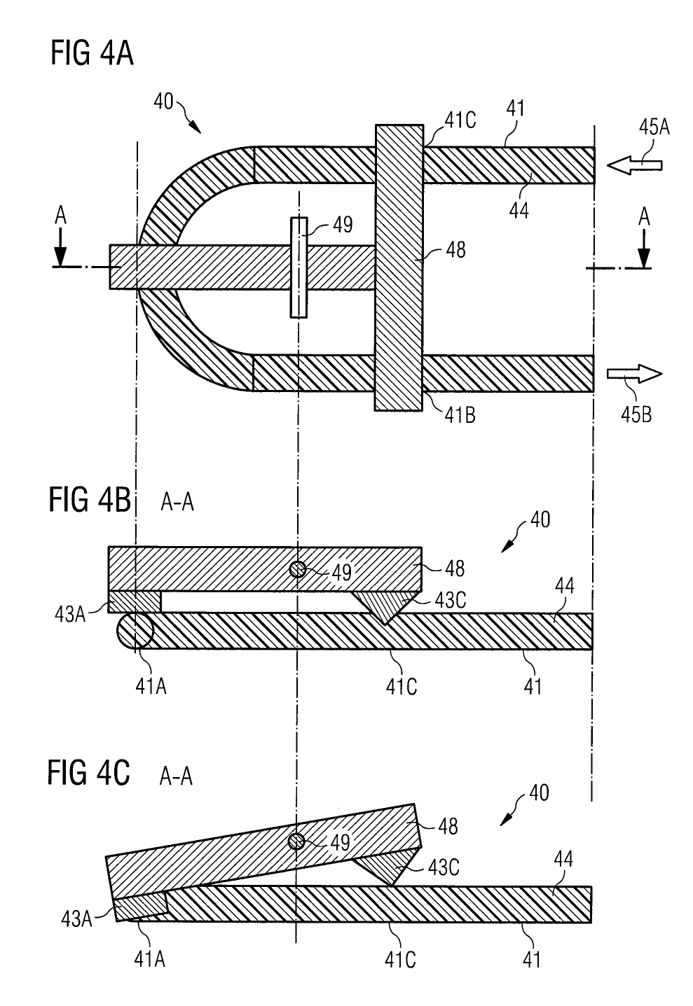

A tube geometry is shown in FIG. 4. FIG. 4A shows a top view of the valve 40. FIG. 4B shows a section along the line A-A with a completely opened valve 40. FIG. 4c shows a section along the line A-A with a completely closed valve 40.

The tube 41 of the valve 40 is arranged in a u-shape. Arrows 45A and 45B show the flow direction of the medium 44 through the tube 41. The primary tube squeezing apparatus 43A acts on a flexible tubular segment 41A, which is located in the summit of the “U” formed by the tube 41. The second tube squeezing apparatuses (e.g., only the tube squeezing apparatus 43C of the inflow can be seen in the sectional representation) act on flexible tubular segments 41B and 41C, which are found in the arms of the “U”.

In one exemplary embodiment, the tube squeezing apparatuses are coupled to a rocker 48, which is rotatably mounted in an axis 49. One arm of the rocker 48 supports the primary tube squeezing apparatus 43A, the other arm is T-shaped and supports the two secondary tube squeezing apparatuses.

The two secondary tube squeezing apparatuses compress the respective tubular segments 41B, 41C in the opened valve state (FIG. 4B) to such a degree that media volumes displaced as a result corresponds at least approximately to half of the media volumes displaced by the assigned tubular segment 41A when the primary tube squeezing apparatus 43A (FIG. 4C) is closed.

The geometry and arrangement of the moveable parts, such as the tube squeezing apparatuses 43A-C, rocker 48 and the respective rocker arms, may be selected such that the change in volume produced by the movement of the primary squeezing apparatus 43A in the squeezing area 41A is at least approximately twice as large as the opposite movement of the secondary squeezing apparatuses in each instance.

The modifications described in conjunction with FIG. 3 may be used in the exemplary embodiment of FIG. 4. To avoid repetitions, reference is made to the corresponding text passages of the description of figures relating to FIG. 3.

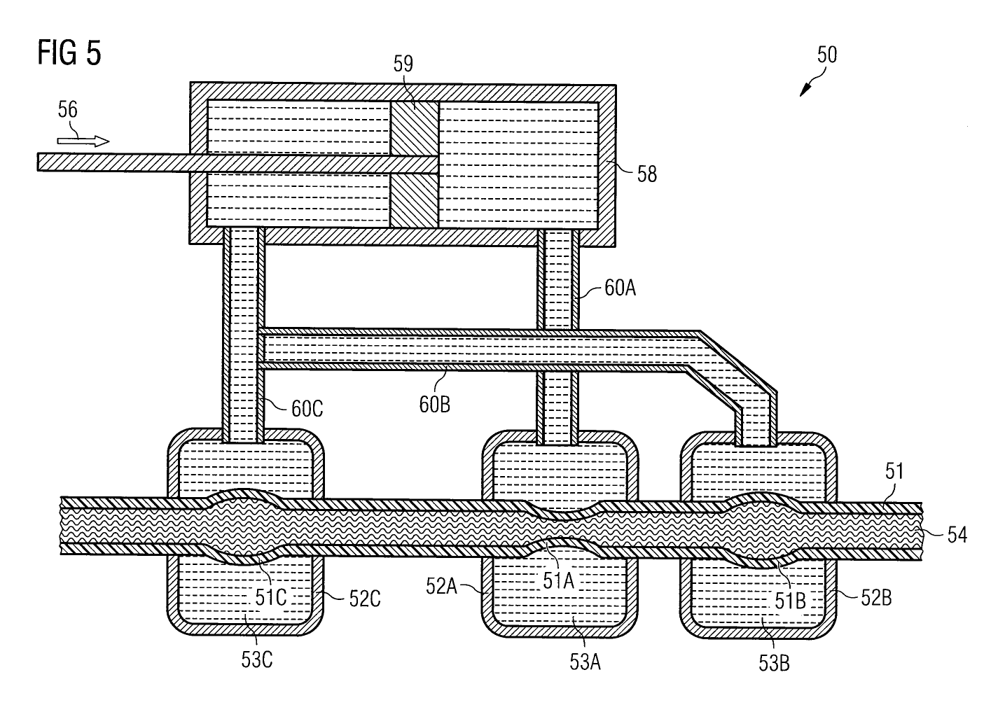

FIG. 5 shows a hydraulically operated squeeze valve 50. A line 51 has three flexible segments 51A-C, with the average segment 51A fulfilling the actual valve function and segments 51B and 51C being used for the pressure/volume equalization. The flexible segments 51A-C may be surrounded in each instance by pressure tanks 52A-C, which are filled with foreign medium 53. Squeeze valve 50 is closed by the pressure in the primary tank 52A being increased, with the flexible tubular part 51A within the pressure tank 52A being pressed together accordingly and in this way reducing the tubular diameter which is effective in respect of transporting a medium 54.

The pressure in the secondary pressure tanks 52B and 52C is reduced at the same time so that tubular parts 51B and 51C arranged within this pressure tank extend. The valve apparatus 50 is constructed such that the volume released by tubular parts 51B and 51C corresponds here to at least approximately half of the volume displaced by the tubular part 51A.

Contrary to the mechanical valves 30 and 40 known from FIG. 3 and FIG. 4, no pre-stress need be applied to the equalization sites in the opened valve state in the hydraulic valve 50 according to FIG. 5. Instead, the equalization can be effected by generating a subpressure in the secondary pressure tanks 52B and 52C.

A suitable coupling of the pressure tanks allows the volume released by the tubular parts 51B and 51C to correspond here at least approximately to half of the volume displaced by the tubular part 51A.

One possible coupling is shown in FIG. 5. A common cylinder 58 filled with foreign medium has two boreholes. The first borehole feeds the primary tank 52A by a supply line 60A. A second borehole, with which two supply lines 60B and 60C are connected, feeds the secondary tanks 52B and 52C. A piston 59 is arranged between the boreholes. Moving the piston 59 in the direction of arrow 56 results in the desired drop in pressure in the primary container 52A and at the same time in the drop in pressure in the secondary containers 52B and 52C. The same quantity of foreign medium is pushed into the primary container 52A as is removed from the two secondary containers 52B and 52C, for example, half of the volume pressed into the primary container 52A is removed from each of the secondary containers 52B and 52C. As a result, the tubular part 51A is compressed by the volume, while the tubular parts 51B and 51C expand by half of this volume in each instance.

This also applies to the embodiment according to FIG. 5, such that pressure and/or volume outside the valve do not change as a result of actuating the valve. Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A squeeze valve, comprising:
a first flexible tubular segment, the cross-section of the first flexible tubular segment being influenced by a first tube squeezing apparatus; and
a second flexible tubular segment, the cross-section of the second flexible tubular segment being changed by a second tube squeezing apparatus, the tube squeezing apparatuses being controlled such that an opening process of the second tubular segment is executed at the same time as a closing process of the first tubular segment.

2. The squeeze valve as claimed in claim 1, the first and second tube squeezing apparatuses being dimensioned such that when actuating the tube squeezing apparatuses, the change in volume at the second tubular segment corresponds at least approximately to half of the change in volume at the first tubular segment.

3. The squeeze valve as claimed in claim 1, further comprising a third flexible tubular segment, which is arranged on the side of the valve facing away from the second tubular segment, and the cross-section of the third flexible tubular segment being changed by a third tube squeezing apparatus, with the third tube squeezing apparatus being controlled such that an opening process of the third tubular segment is executed at the same time as the closing process of the first tubular segment.

4. The squeeze valve as claimed in claim 3, the tube squeezing apparatuses of which are dimensioned such that when actuating the tube squeezing apparatuses the change in a volume at the third tubular segment corresponds at least approximately to half of a change in the volume at the first tubular segment.

5. The squeeze valve as claimed in claim 1, wherein the tube squeezing apparatuses are mechanically, hydraulically or pneumatically actuated.

6. The squeeze valve as claimed in claim 1, wherein the tube squeezing apparatuses are coupled mechanically, hydraulically or pneumatically.

7. The squeeze valve as claimed in claim 4, wherein the tube squeezing apparatuses are mechanically, hydraulically or pneumatically actuated.

8. The squeeze valve as claimed in claim 4, wherein the tube squeezing apparatuses are coupled mechanically, hydraulically or pneumatically.
